(19) United States
(12) Patent Application Publication
(10) Pub. No.: US 2009/0265183 A1
(43) Pub. Date: Oct. 22, 2009

(54) METHOD OF MANAGING A WELLNESS PROGRAMME AND A SYSTEM THEREFOR

(76) Inventors: Alan Pollard, Sandton (ZA); Craig Nossel, Johannesburg (ZA)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/262,266

(22) Filed: Oct. 31, 2008

(30) Foreign Application Priority Data
Apr. 22, 2008 (ZA) 2008/03529

(51) Int. Cl. G06Q 50/00; G06Q 99/00

(52) U.S. Cl. 705/2; 705/14

(57) ABSTRACT

A method and system for managing a wellness programme includes obtaining personal information pertaining to an individual, the personal information including at least the individual's age and gender. In addition, health information pertaining to the individual is obtained. The health information typically includes at least one of exercise, diet, smoking, blood pressure, cholesterol and weight. The personal information and the health information are then used to determine a wellness programme for the individual, the wellness programme including a plurality of programme areas with which the individual must comply. Information is then received regarding the individual's compliance or non-compliance with the individual's wellness programme and points are awarded to the individual for compliance with the wellness programme. At predetermined intervals the total number of points awarded to the individual are calculated and a reward is awarded to the individual based on the total number of points accumulated.

### BACKGROUND OF THE INVENTION

The present invention relates to a method of managing a wellness programme and a system therefor.

Various wellness programmes are known which attempt to encourage an individual to look after their wellness.

However, these wellness programmes often fall short in that they are not personalised for an individual but are rather general wellness programmes that are offered to a number of individuals.

One of the effects of general wellness programmes is that they lack a personal incentive aspect to motivate the individual to look after their health.

The present invention seeks to address this.

### SUMMARY

According to one example embodiment there is provided a method of managing a wellness programme, the method including:
obtaining personal information pertaining to an individual, the personal information including at least the individual's age and gender;
obtaining health information pertaining to the individual;
using the personal information and the health information to determine a wellness programme for the individual, the wellness programme including a plurality of programme areas with which the individual must comply;
receiving information regarding the individual's compliance or non-compliance with the individual's wellness programme;
awarding points to the individual for compliance with the wellness programme;
at predetermined intervals, calculating the total number of points awarded to the individual; and
awarding a reward to the individual based on the total number of points accumulated.

The health information may include lifestyle factors such as exercise, diet, and smoking, as well as clinical factors such as blood pressure, cholesterol and weight

The method may include:
using the personal information and the health information to determine the health risk of the individual; and
using the health risk of the individual as a factor to determine the reward awarded to the individual.

According to another example embodiment there is provided a system for managing a wellness programme, the system including:
an information obtaining module to obtain personal information pertaining to an individual, the personal information including at least the individual's age and gender and to obtain health information pertaining to the individual;
a wellness programme determining module to use the personal information and the health related information to determine a wellness programme for the individual, the wellness programme including a plurality of programme areas with which the individual must comply;
a monitoring module to receive information regarding the individual's compliance or non-compliance with the individual's wellness programme; and
an awards module to award points to the individual for compliance the wellness programme and at predetermined intervals to calculate the total number of points awarded to the individual and then to award a reward to the individual based on the total number of points accumulated.

The system may include a health risk calculation module to use the personal information and the health information to calculate a relative health risk of the individual.

In this case, the awards module uses the calculated relative health risk of the individual as a factor to determine the reward awarded to the individual.

The health information may include at least one of exercise, diet, smoking, blood pressure, cholesterol and weight.

In one example, the health information is obtained via a communications network.

The health information may be obtained by the information obtaining module transmitting questions via the communications network to the individual and receiving answers from the individual via the communications network such as the Internet.

The plurality of programme areas determined by the wellness programme determining module may include one or more of manage blood sugar level, reduce cholesterol level, stop smoking, lose weight, increase physical activity, improve diet, reduce alcohol intake.

In addition, the information received regarding the individual's compliance or non-compliance may be received via a communications network.

In one example, the awards module further:
defines ranges of points and associates different status levels with each of the ranges of points;
determines a status level for the individual based on the amount of points awarded to them; and
determines the reward amount based on the status level.

### BRIEF DESCRIPTION OF THE DRAWINGS

FIG. 1 is a flow chart illustrating the methodology of an example embodiment; and

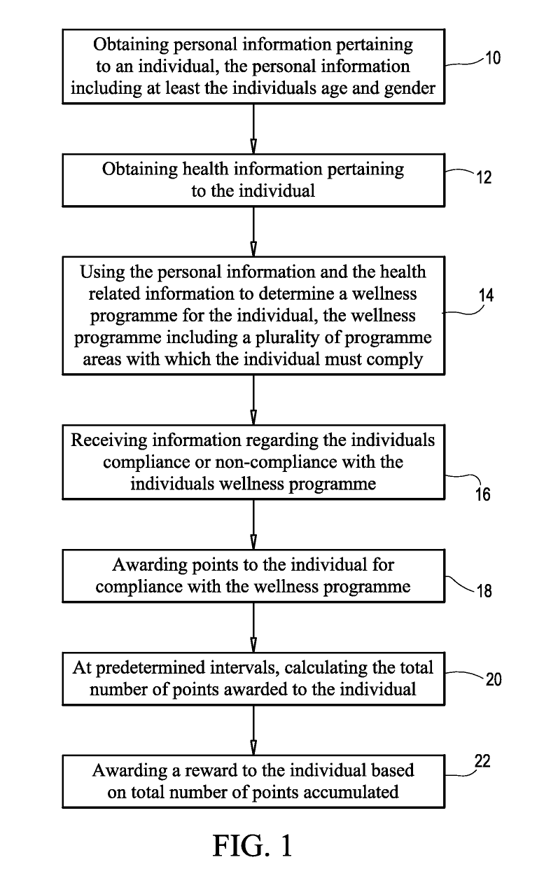

FIG. 2 is a block diagram illustrating an example system to implement the methodologies described herein.

### DESCRIPTION OF AN EMBODIMENT

Referring to the accompanying diagrams, according to one example embodiment there is provided a method of managing a wellness programme.

It will be appreciated that the method and system described below could be implemented by any suitable party acting as the wellness programme manager. This would include a health insurance operator, a life insurance operator, an employer that implements the programme for their employees or a third party that implements the programme on behalf of the above entities. In addition, the wellness programme manager could be a separate entity that implements the programme and offers it to any individual that wants to join the wellness programme which therefore operates as a stand alone programme.

In any event, the method includes obtaining personal information pertaining to an individual. The personal information including at least the individual's age and gender.

In addition, the method includes receiving health information pertaining to the individual.

The health information includes lifestyle factors such as exercise, diet, and smoking to name but a few examples, as well as clinical factors such as blood pressure, cholesterol and weight to name but a few examples.

For example, the health information includes information relating to the individual's current health and includes at least some of the individual's eating habits, whether they are a smoker or a non-smoker, their exercise habits and whether or not they have any chronic health conditions to name but a few examples.

The personal information and/or the health information are typically at least partially obtained from the individual by the individual completing a questionnaire.

In one example embodiment the questionnaire is implemented as an interactive tool that the user can access and complete via a communications network. The communications network may be the Internet, for example. In this example, questions are provided to the individual via the Internet and the user's answers are received via the Internet.

In addition to the questionnaire, further health information may be obtained from the individual by requiring the individual to have a number of health related tests. For example these may include one or more of a blood pressure measurement, a blood glucose measurement, a cholesterol test, a tobacco usage test, a cardiovascular health test, a height measurement and a weight measurement.

The personal information and the health related information are then used as part of a health risk assessment and ultimately used to determine a tailored wellness programme for the individual.

The wellness programme will typically include a plurality of programme areas with which the individual must comply.

In addition, the method includes using the personal information and the health information to calculate a relative health risk of the individual and then using the calculated relative health risk of the individual as a factor to determine the reward awarded to the individual.

Based on the health and lifestyle factors which include amount of physical activity, dietary habits, smoking status, as well as existence of certain chronic diseases, the impact of lifestyle behaviours and health parameters for the individual are calculated and shown how this may increase morbidity and mortality. From this the points available are recalibrated so that they are weighted according to the individual's health risk factors. In addition, the scoring helps determine which areas the individual needs to focus on for their health to improve and a pathway for the individual is created to follow where their points are weighted according to their health risks. As the health risks are adjusted, so are their points and programme adjusted.

Examples of such wellness programmes tailored for individuals are as follows.

Sally is 37 years old, does no exercise, only eats 2 servings of vegetables and fruit daily and is Diabetic. In addition, she smokes, has a raised cholesterol level and is overweight. Her blood pressure is within the normal range, despite having at least 3 whiskeys every evening!

Her calculated health age is 58 or health risk. This is based on the relative risk that her lifestyle and health factors pose. The fact that she smokes adds a certain risk to her from a mortality perspective with regards to chronic diseases of lifestyle. This is represented as an increased age. So each of these factors have a number linked to them with 1.0 being zero risk, less than 1.0 if the lifestyle factor such as exercise provides health benefits thus providing longevity and greater than 1 if a health risk is posed. This calculation will change overtime as new clinical evidence develops.

The overall risk is the difference between Vitality Age and the person's chronological age as a percentage.

A tailored wellness programme for Sally highlights the following areas of risk and allocates points to these areas.

| | Increased Risk | Personal Points |
|---|---|---|
| Diabetes | 76 | 6,000 |
| Cholesterol | 68 | 5,500 |
| Smoking | 53 | 4,500 |
| BMI | 51 | 4,000 |
| Physical activity | 32 | 2,500 |
| Alcohol intake | 29 | 1 |
| Nutrition | 25 | 2,000 |

There are currently no activities or goals linked to alcohol therefore a ‘1’ is inserted. However it will be appreciated that this may not be the case.

The number of points are calculated and allocated based on the individual's overall risk. For example, someone who has a risk that is double what it should be will be allocated 50% more points than someone who is healthy. The additional points that are allocated to the individual will be linked to the various health and lifestyle risk factors that pertain to that individual. Thus the total available points are first calculated and then divided up into the different risk factors based on the weightings associated with those factors.

In this example the diabetes is the most significant risk factor so most of the points are allocated to that factor, then cholesterol etc. If insufficient physical activity is the only risk factor (as per example below) all the additional points will be allocated to that.

Based on the above Sally would be allocated points if she met the following targets.

| Sally's Personal Pathway | Available points | |
|---|---|---|
| (Programme Areas) | (24 000) | My personal goal |
| Manage your HbA1C | 6 000 | I will reduce my BMI by |
| Reduce your cholesterol | 5 500 | 10% in the next 3 months |
| Stop smoking! | 4 500 | |
| Lose weight | 4 000 | |
| Increase your physical | 2 500 | |
| activity | | |
| Improve your diet! | 2 000 | |
| Reduce your alcohol intake | Referral to | |
| | credible alcohol | |
| | partners (eg AA; | |
| | SANCA) | |

It is worth noting that HbA1C is the hemoglobin A1c test that is a simple lab test that shows the average amount of sugar in a person's blood over the last two to three months. It's an effective way to find out if a person's blood sugar is under control. It will be appreciated that any other suitable test could be used.

Where the goal is defined like stopping smoking Sally will obviously be awarded all of the 4 500 points for stopping smoking and none if she does not.

However, where the goal is not so defined there will typically be amounts associated with the goal. So Sally will be asked to lose a certain amount of weight before she is allocated the 4 000 points for losing weight. This may be tiered so that reaching certain thresholds will give the individual access to certain rewards or greater rewards

The personal goal column is suggested by Sally after she has been shown what her risk factors are and she is then provided with additional incentive (points) to set a particular short term goal which she can choose from the list.

In another example, Bob is 31 years old, finds exercise difficult and does not like vegetables & fruit. He smokes and drinks alcohol in excess. Despite his unhealthy lifestyle habits, his health measurements are all in the normal range.

His calculated health age is 37.

A tailored wellness programme for Bob highlights the following areas of risk and allocates points to these areas.

| | Increased Risk | Personal Points |
|---|---|---|
| Smoking | 53 | 4,500 |
| Physical activity | 32 | 2,500 |
| Alcohol | 29 | 1. |
| Nutrition | 25 | 2,000 |

Based on the above Bob would be allocated points if he met the following targets.

| My Personal Pathway | Available points | |
|---|---|---|
| (Programme Areas) | (9 000) | My personal goal |
| Stop smoking! | 4 500 | I will quit in the next 3 |
| Increase your physical activity | 2 500 | months |
| Improve your diet! | 2 000 | |
| Reduce your alcohol intake | Referral to | |
| | credible alcohol | |
| | partners (eg AA; | |
| | SANCA) | |

In a further example, Alan is a healthy 40 year old male but needs encouragement to exercise a bit more—he currently manages about 45 minutes per week. His vegetable and fruit intake is average (4 servings daily) and his cholesterol is 4.5 mmol/l.

His calculated health age is 41.

A tailored wellness programme for Alan highlights the following areas of risk and allocates points to these areas.

| | Increased Risk | Personal Points |
|---|---|---|
| Physical activity | 32 | 1,000 |
| Nutrition | 25 | 500 |
| Cholesterol level | 23 | 500 |

Based on the above Alan would be allocated points if he met the following targets.

| | Available | |
|---|---|---|
| | points | |
| My Vitality Personal Pathway | (2 000) | My personal goal |
| Increase your physical activity | 1 000 | I will become fit enough to |
| Improve your diet! | 500 | reach level 4 at my next |
| Manage your cholesterol | 500 | Vitality Fitness |
| | | Assessment! |

In a final example, at 25 Jacoline is the picture of health. Her healthy lifestyle is keeping her calculated health well below her actual age!

Her calculated health age is 22.5.

Her only goal is therefore to maintain her current status.

Jacoline may obtain points based on a general wellness programme points structure ie for going to gym, but will not be given any additional points as she is not at risk.

In order to assist the individual comply with their programme, they are assisted with access to the facilities and/or services required by them. For example, the member's gym membership is at least partially subsidised to allow the member more affordable access to the gym. This may be implemented by entering into an agreement with designated gyms whereby at least a portion of the member's gym fees are paid on behalf of the member or where a reduced fee is negotiated on the member's behalf.

Similar access would be afforded to the member to other health related facilities and or services such as to a smoke ending program or a weight loss program, for example.

Once the member has their wellness programme, information is received periodically regarding the individual's compliance or non-compliance with their wellness programme.

In one embodiment, this information is typically received directly from the third party health related facilities and or services. By way of illustration, the gym which the member attends may collect information on the member's attendance at the gym and then periodically pass this information onto the managers of the wellness programme. This information can be passed on via a communications network between the gym, for example, and the manager of the wellness programme.

The member may also be required to again complete the questionnaire described above and/or re-submit themselves for testing at periodic intervals and the results of this testing and questionnaire are then used to assess the member's compliance with their individual programme.

Points are awarded to the individual for compliance with the wellness programme and in accordance with their personal targets that have been set out for them.

At predetermined intervals, the total number of points awarded to the individual is calculated and a reward is then awarded to the individual based on the total number of points accumulated.

In one example, the points are used to determine a status level so that points falling within specific ranges are associated with a status level. In one example, the status levels could be blue, bronze, silver, gold and platinum with blue being the lowest level and platinum being the highest level. The reward amount is then linked to the status level.

The reward could take any one of a number of forms including one or more of cash payments; discounts on purchases at partner stores; reduced or free airline tickets, hotel accommodation and car rental; donations to a charity of choice of the member—to name but a few examples.

The amount of the reward is related to the total number of points awarded to the individual, in one example by using the status levels described above.

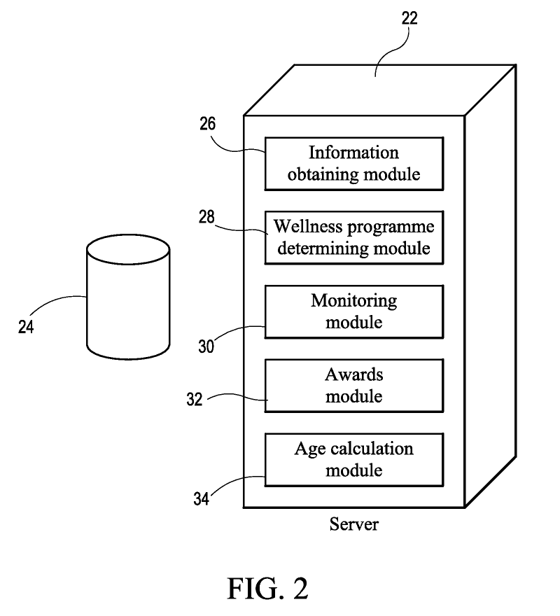

Referring to FIG. 2, there is provided an example embodiment of a system for implementing the abovementioned method of managing a wellness programme.

The system includes a processor included in a server 22 disposed in communication with a memory 24.

The processor 22 includes modules which are implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

The system includes an information obtaining module 26 to obtain personal information pertaining to an individual, the personal information including at least the individual's age and gender and to obtain health information pertaining to the individual.

As described above, in one example embodiment, the information obtaining module 26 provides an on-line questionnaire to the individual to be completed by the individual interactively. The individual's answers to the questionnaire are stored in the memory 24 which may take the form of a database.

A wellness programme determining module 28 uses the personal information and the health related information to determine a wellness programme for the individual, the wellness programme including a plurality of programme areas with which the individual must comply as has been described above.

A monitoring module 30 receives information regarding the individual's compliance or non-compliance with the individual's wellness programme and an awards module 32 awards points to the individual for compliance the wellness programme and at predetermined intervals to calculate the total number of points awarded to the individual and then to award a reward to the individual based on the total number of points accumulated as has been described above.

The system also includes a relative health risk calculation module 34 to use the personal information and the health information to calculate a relative health risk of the individual.

In this case, the awards module uses the calculated relative health risk of the individual as a factor to determine the reward awarded to the individual.

Thus it will be appreciated that a wellness programme is tailored for an individual rather than the individual having to comply with a general wellness programme.

We claim:

1. A method of managing a wellness programme, the method including:
obtaining personal information pertaining to an individual, the personal information including at least the individual's age and gender;
obtaining health information pertaining to the individual;
using the personal information and the health information to determine a wellness programme for the individual, the wellness programme including a plurality of programme areas with which the individual must comply;
receiving information regarding the individual's compliance or non-compliance with the individual's wellness programme;
awarding points to the individual for compliance with the wellness programme;
at predetermined intervals, calculating the total number of points awarded to the individual; and
awarding a reward to the individual based on the total number of points accumulated.

2. A method according to claim 1 wherein the health information includes at least one of exercise, diet, smoking, blood pressure, cholesterol and weight.

3. A method according to claim 1, the method including:
using the personal information and the health information to determine the health risk of the individual; and
using the health risk of the individual as a factor to determine the reward awarded to the individual.

4. A method according to claim 1, wherein the health information is obtained via a communications network.

5. A method according to claim 4, wherein the health information is obtained by transmitting questions via the communications network to the individual and receiving answers from the individual via the communications network.

6. A method according to claim 5, wherein the communications network is the Internet.

7. A method according to claim 1 wherein the plurality of programme areas include one or more of manage blood sugar level, reduce cholesterol level, stop smoking, lose weight, increase physical activity, improve diet, reduce alcohol intake.

8. A method according to claim 1 wherein the information received regarding the individual's compliance or non-compliance is received via a communications network.

9. A method according to claim 1 further comprising:
defining ranges of points and associating different status levels with each of the ranges of points;
determining a status level for the individual based on the amount of points awarded to them; and
determining the reward amount based on the status level.

10. A system for managing a wellness programme, the system including:
an information obtaining module to obtain personal information pertaining to an individual, the personal information including at least the individual's age and gender and to obtain health information pertaining to the individual;
a wellness programme determining module to use the personal information and the health related information to determine a wellness programme for the individual, the wellness programme including a plurality of programme areas with which the individual must comply;
a monitoring module to receive information regarding the individual's compliance or non-compliance with the individual's wellness programme; and
an awards module to award points to the individual for compliance the wellness programme and at predetermined intervals to calculate the total number of points awarded to the individual and then to award a reward to the individual based on the total number of points accumulated.

11. A system according to claim 10 where the system includes a health risk calculation module to use the personal information and the health information to calculate a relative health risk of the individual.

12. A system according to claim 11 wherein the awards module uses the calculated relative health risk of the individual as a factor to determine the reward awarded to the individual.

13. A system according to claim 10 wherein the health information includes at least one of exercise, diet, smoking, blood pressure, cholesterol and weight.

14. A system according to claim 10, wherein the health information is obtained via a communications network.

15. A system according to claim 14, wherein the health information is obtained by the information obtaining module transmitting questions via the communications network to the individual and receiving answers from the individual via the communications network.

16. A system according to claim 15, wherein the communications network is the Internet.

17. A system according to claim 10 wherein the plurality of programme areas determined by the wellness programme determining module include one or more of manage blood sugar level, reduce cholesterol level, stop smoking, lose weight, increase physical activity, improve diet, reduce alcohol intake.

18. A system according to claim 10 wherein the information received regarding the individual's compliance or non-compliance is received via a communications network.

19. A system according to claim 10, wherein the awards module further:
defines ranges of points and associates different status levels with each of the ranges of points;
determines a status level for the individual based on the amount of points awarded to them; and
determines the reward amount based on the status level.
